(19) United States
(12) Patent Application Publication
(10) Pub. No.: US 2004/0202829 A1
(43) Pub. Date: Oct. 14, 2004

(54) Identification media having a security image

(76) Inventor: John Michael Zercher, Columbia, PA (US)

Correspondence Address: Bruce J. Wolstoncroft, Esquire, Barley, Snyder, Senft & Cohen, LLC, 126 East King Street, Lancaster, PA, 17602, US

(21) Appl. No.: 10/138,205

(22) Filed: May 3, 2002

(51) Int. Cl. B32B 3/10; B32B 7/02

(52) U.S. Cl. 428/195.1; 428/203; 428/76; 283/94; 156/233; 428/212

(57) ABSTRACT

This and other objects are achieved by providing a security image on a substrate. The security image is formed by first stamping or otherwise transferring a first foil section on a substrate wherein the first foil section has a first sheen. A second and optionally subsequent foils are stamped or otherwise transferred over the first foil section in the form of an image or pattern. The second or subsequent foils are of a different sheen than the first foil.

### FIELD OF THE INVENTION

The present invention is related to identification and other types of media and more particularly to the application of security images to such media.

### BACKGROUND OF THE INVENTION

Identification and other types of media such as credit cards increasingly require added security features. Security features include holograms which are presently applied over a foiled section. Application of a holographic image requires specialized machinery to create multicolored defractive images in a holographic relief pattern on a substrate.

One example of such a method is shown in U.S. Pat. No. 4,758,296 which discloses a method of making surface relief holograms wherein hot stamping foils are used for applying defractive or holographic anti-counterfeiting features to credit cards, identification cards, passports, secured documents, certificates and the like. The holographic relief pattern can be applied over a foil section which is typically hot stamped onto the card. Multicolored defractive images are composed from segments of the foil with regions of different color being formed by foils having different average spatial frequency.

U.S. Pat. Nos. 5,759,683 and 5,464,690 disclose a holographic article wherein an apparatus and process is used for hot stamping small areas of a composite sheet onto a document substrate in order to create a chip. A holographic image is then embossed over the chip.

U.S. Pat. No. 4,006,050 discloses a card produced by a xerography method. There, a press is used for transferring stamping foils and heat transfers onto a card. A die of the press may be textured or have an overall pattern to make forgery difficult. The die is used over a transfer sheet with an image carried thereon laid face downwards on the top of a plastic base or card to create the texture.

U.S. Pat. No. 4,933,120 teaches a technique and apparatus for printing a hologram directly on paper or a sheet of other material. The material or paper is sequentially passed through printing and hologram forming stations. This process requires the application of a thin layer of reflective material to the surface relief pattern so that light is reflected and defracted onto an image of the hologram.

The creation of holographic images is a relatively expensive method for producing security features on a card or other substrate, but they provide the best form of security because is they are relatively difficult to replicate. While other references suggest the use of hot stamped foils and heat transfers onto a card, these do not provide a relatively high level of security because of the relative ease with which they may be duplicated. What is needed is a security feature which simulates the level of security provided by a holographic image while being produceable by a relatively less costly method.

### SUMMARY OF THE INVENTION

It is therefore an object of the invention to provide a relatively simple foil security feature for application on substrates such as credit cards, identification cards, passports, secured documents, certificates and the like. This and other objects are achieved by providing a security image on a substrate. The security image is formed by first stamping or otherwise transferring a first foil section on a substrate wherein the first foil section has a first sheen. A second foil is stamped or otherwise transferred over the first foil section in the form of an image or pattern. The second foil is of a different sheen than the first foil. Subsequent foils of differing sheens may optionally be applied over or adjacent to the second foil.

### BRIEF DESCRIPTION OF THE DRAWINGS

The invention will now be described by way of example with reference to the accompanying figures of which:

FIG. 1 shows an exploded perspective view of an identification card having the security image of the present invention.

FIG. 2 shows a perspective view of successive transfer sections utilized in manufacturing the card of FIG. 1.

FIG. 3 shows a top view of a completed identification card of FIG. 1.

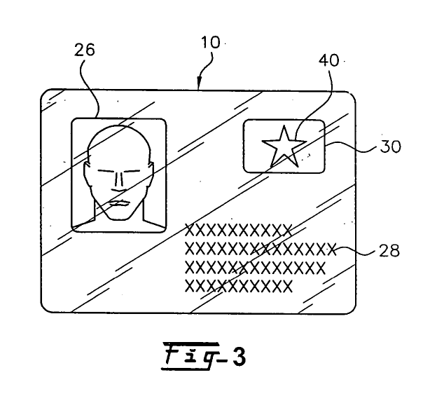

### DETAILED DESCRIPTION OF THE INVENTION

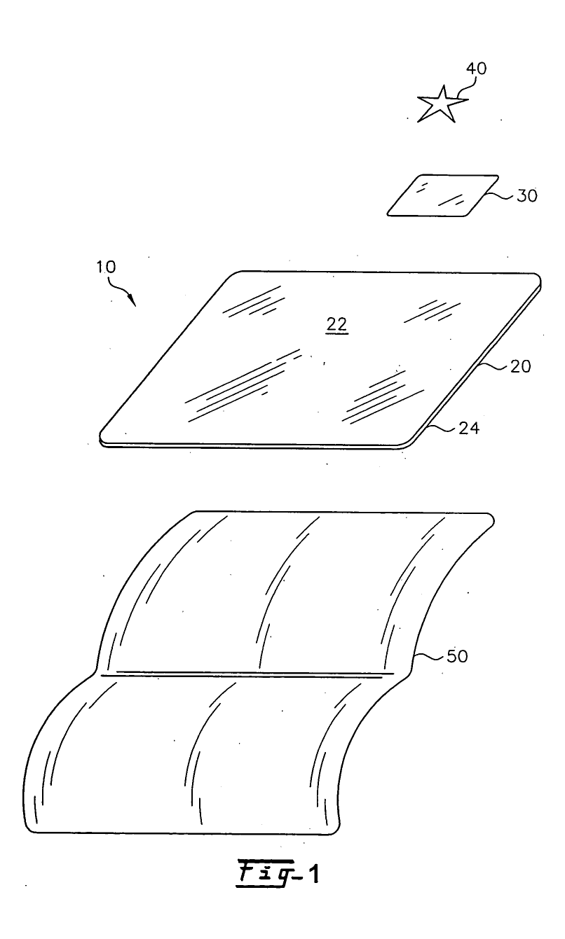

The invention will first be described generally with reference to FIG. 1. It should be understood that while the invention will be described by the exemplary embodiment of an identification card, this invention may be utilized with any suitable substrate to create other media such as passports, secured documents, certificates and the like. A card 10 is shown in FIG. 1 having four major components. First, a substrate 20 is provided for receiving images, text, and security features on both or either of its major surfaces 22, 24. A first foil section 30 is applied on the first major surface 22 and a second or subsequent foil images 40 are applied over the first foil section 30. The substrate 20 may be optionally laminated utilizing a laminant sleeve 50.

Each of the major components will be described in greater detail with reference once again to FIG. 1. First, the substrate 20 may consist of known PVC materials, TESLIN, or other suitable substrates for creating an identification, credit card or other media. It should also be understood that the substrate 20 may include other materials such as paper or other plastics which may be utilized in creating passports, secured documents, certificates, tags or other media. The substrate 20 material is only limited to a group of materials which is suitable for applying a foil or foil transfer thereon. The substrate 20 has two major surfaces 22, 24. In this exemplary embodiment, a photo 26, text 28, a bar code or other security features may be printed or otherwise applied on the first major surface 22 by well known techniques. Similarly, a bar code, magnetic strip, text, or other images may be printed or otherwise applied on the second major surface 24 also by well known techniques which are suitable for the particular material selected for the substrate 20.

The first foil section 30 is applied over the substrate 20 on one of the major surfaces 22, 24. Here, in FIG. 1, the first foil section 30 is shown as being applied on the first major surface 22. This foil section 30 may be applied by a hot stamping or other transfer process which is suitable for the foil material selected. A typical foil material for use in this application is commercially available from API foils, or Crown Roll Leaf and sold under trade names Holografx™ and Holofoil®. It should be understood that while these are suitable foil materials, the invention is not limited to their use and any transferable foil material may be utilized. The first foil section 30 has a sheen which may be a high sheen to provide a high degree of light reflection from the surface thereof.

It should be understood that while a second foil image 40 will now be described, subsequent foil images may also be applied over either the first section 30 or over the second foil image 40. Subsequent foil images may be applied utilizing foils of differing sheens to create contrast between layers.

A second foil image 40 is applied over the first foil section 30 by a similar heat stamping or transfer process. The second foil image 40 is also commercially available from API foils or Crown Roll Leaf as described above without limitation. The second foil image 40 takes a shape of an image, pattern, text, logo or insignia and is applied within the area of the first foil section 30. The second foil image 40 is preferably of a different sheen than the foil section 30 and optimally of a lower sheen than the first foil section 30 in order to provide light reflective contrast therebetween.

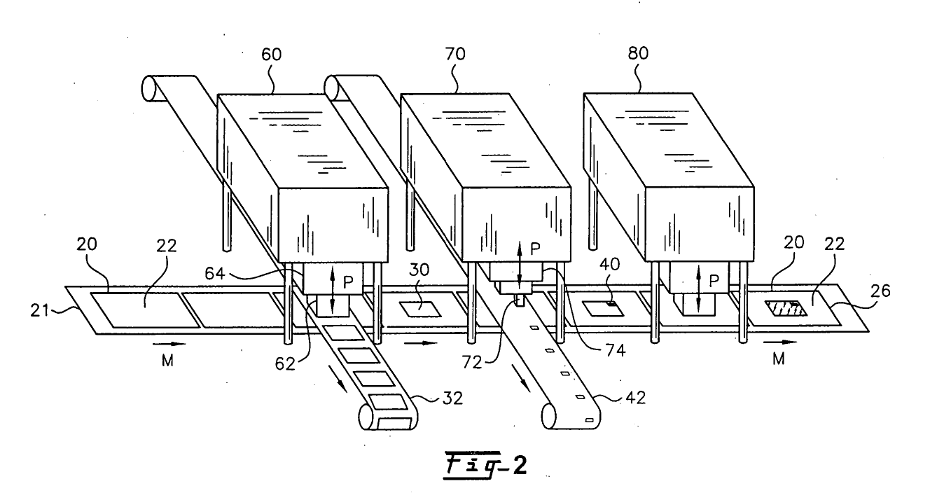

The method of making the card 10 of FIG. 1 will now be described with reference to FIG. 2. The substrate 20 is supplied to various stations 60, 70, 80 along a continuous sheet 21. The continuous sheet 21 is shown here as having a single row of cards 20 however the continuous sheet 21 may take various other matrix formats in the assembly process. The sheet 21 enters a first transfer station 60 wherein the first foil section 30 is applied. The first foil section 30 is supplied to the transfer station along a first continuous roll 32. The transfer station 60 includes a die 62 extending from a press 64. Depending upon the foil material, the die 62 may be heated in order to perform the transfer or may simply apply pressure to transfer the foil from the continuous roll 32 onto the substrate 20. This die 62 is moved by the press 64 in the direction of the arrow P perpendicular to the direction of motion M of the substrate 20. The die 62 is preferably a flat surface die to create the first foil section 30 in a desired location on the first major surface 22 of the substrate 20. The substrate 20 then progresses in the direction M towards the second station 70 where a similar press 74 has a die 72 extending therefrom. The die 72 transfers foil material from a second continuous roll 42 to create the foil image 40 over the first foil section 30 on the first major surface 22. This die 72 is different, however, in that it preferably comprises the shape of an image, text, pattern or logo according the requirements of the security features. The die 72 similarly may be heated or simply pressed over the roll 42 as required by the material for achieving appropriate transfer. The substrate 20 continues to move along the direction M toward a third station 80 wherein various text, images or other features may be applied by printing or other well known techniques. It should be understood by those reasonably skilled in the art that while application of these features have been shown here in three stations 60, 70, 80 on a first major surface 22, this process is as equally applicable to the opposite major surface 24 of the substrate 20. Also, additional stations may be added for applying subsequent foils as described above. After exiting the third station 80, the substrate 20 may be separated into appropriate sized cards along perforations 26. Optionally, those cards may then be laminated by well known techniques to apply a laminant 50 thereover as shown in FIG. 1.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

1. (Cancelled)

2. An improved security feature comprising:
a substrate;
a first foil section being applied to the major surface of the substrate, the first foil having a first sheen;
a second foil having a shape in the form of an image being applied over the first foil, the second foil having a sheen which is different from the first foil, wherein the sheen of the second foil is lower than the sheen of the first foil.

3. The security feature of claim 2, wherein the color of the second foil is different from the color of the first foil.

4. The security feature of claim 2 further comprising subsequent foils having a shape in the form of an image being applied over the second foil.

5. The security feature of claim 2 wherein the substrate is TESLIN.

6. The security feature of claim 2 wherein the substrate is PVC.

7. The security feature of claim 2 wherein the substrate and foil are enclosed by a laminant material.

8. The security feature of claim 2 wherein the substrate further comprises printing thereon.

9. The security feature of claim 2 wherein the substrate further comprises an image on the major surface.

10. A method of applying a security feature to a substrate comprising the steps of:
transferring a first foil having a planar shape onto an area of a major surface of a substrate by pressing;
transferring a second foil over the first foil wherein the second foil is formed in a shape to be within the planar shape of the first foil.

11. The method of claim 10 further comprising the step of transferring a subsequent foil over the second foil where the subsequent foil is formed in a shape to be within the planar shape of the first foil.

12. A method of providing security, comprising:
placing a first foil section of a substrate and the first foil having a first sheen;
placing a second foil having a shape in the form of an image over the first foil, the second foil has a lower sheen then the first foil.

13. A system of providing security, comprising:
surface means;
a first foil means being applied to the major surface of the surface means, the first foil means having a first sheen means;
a second foil means having a shape in the form of an image being applied over the first foil means, the second foil means having a sheen means which is different from the first foil means, wherein the sheen means of the second foil means is lower than the sheen means of the first foil means.
